(19) United States
(12) Patent Application Publication
(10) Pub. No.: US 2009/0316078 A1
(43) Pub. Date: Dec. 24, 2009

(54) Color Filter Substrate and Liquid Crystal Display using the same

(76) Inventors: Ya-Ling HSU, Hsinchu City (TW); Chien-Kai Chen, Hsinchu City (TW); Chun-Liang Lin, Hsinchu City (TW); Chen-Hsien Liao, Hsinchu City (TW)

Correspondence Address: HDLS Patent & Trademark Services, P.O. BOX 220746, CHANTILLY, VA, 20153-0746, US

(21) Appl. No.: 12/261,342

(22) Filed: Oct. 30, 2008

(30) Foreign Application Priority Data
Jun. 19, 2008 (TW) 097122836

(51) Int. Cl. G02F 1/13357; G02B 5/20; G02F 1/1335

(52) U.S. Cl. 349/70; 359/885; 349/106; 349/61

(57) ABSTRACT

A color filter substrate includes a plurality of green photoresists. A ratio of M1 to M2 is less than or equal to 0.04, and D is less than or equal to 90 nm, wherein M1 represents a maximum value of G(λ)×CMF_×(λ) at a wavelength between 450 nm and 510 nm, M2 represents a maximum value of G(λ)×CMF_×(λ) at a wavelength between 550 nm and 590 nm, CMF_×(λ) represents a Commission Internationale de L'Eclairage (CIE) color matching function, G(λ) represents a transmittance spectrum of each of the green photoresists and D represents a full width at half maximum of a peak of G(λ). The color filter substrate can promote color saturation of a liquid crystal display. Furthermore, a liquid crystal display using the color filter substrate is provided.

### BACKGROUND

1. Technical Field

The present invention relates to a display apparatus, and more particularly to a liquid crystal display and a color filter substrate thereof.

2. Description of the Related Art

With the development of flat panel display technique, flat panel displays (FPDs) that have advantages of light in weight, small in size and low power consumption are becoming more and more popular. Typically, the flat panel displays include liquid crystal displays (LCDs), plasma panel displays (PDPs), organic light emitting diode displays (OLED displays) and electrophoretic displays (EPDs). Among the flat panel displays, the liquid crystal displays are most widely used.

The liquid crystal display includes a liquid crystal display panel and a backlight module. The backlight module can provide a plane light source to the liquid crystal display panel. The liquid crystal display panel has a color filter substrate as an important component thereof. The color filter substrate may filter the plane light source for performing color display.

Because the trend of development of the liquid crystal display is toward high color saturation, the liquid crystal display that supports an sRGB color space can not meet professional requirement gradually, and thus the liquid crystal display that can support an Adobe RGB color space appears.

However, in the backlight module of the liquid crystal display that can support the Adobe RGB color space, the light source is generally composed of light emitting diodes (LEDs). If the LEDs are substituted by Hi-Color cold cathode fluorescent lamps (Hi-Color CCFLs), the Adobe RGB color space would not be covered completely.

FIG. 1 shows a color space on a Commission Internationale de L'Eclairage (CIE) 1931 chromaticity diagram of the conventional liquid crystal display employing the cold cathode fluorescent lamps and an Adobe RGB color space. Referring to FIG. 1, a triangular region 50 represents the Adobe RGB color space and a triangular region 60 represents the color space of the conventional liquid crystal display employing the cold cathode fluorescent lamps. As shown in FIG. 1, the color space of the conventional liquid crystal display employing cold cathode fluorescent lamps can not cover the Adobe RGB color space completely, such as in region R1 (green region) and region R2 (blue region).

### BRIEF SUMMARY

The present invention relates to a color filter substrate to promote color saturation of a liquid crystal display.

The present invention further relates to a liquid crystal display having high color saturation.

To achieve at least one of the above-mentioned advantages, the present invention provides a color filter substrate. The color filter substrate includes a plurality of green photoresists. A ratio of M1 to M2 is less than or equal to 0.04, and D is less than or equal to 90 nm, wherein M1 represents a maximum value of G(λ)×CMF_x(λ) at a wavelength between 450 nm and 510 nm, M2 represents a maximum value of G(λ)×CMF_x(λ) at a wavelength between 550 nm and 590 nm, CMF_x(λ) represents a CIE color matching function, G(λ) represents a transmittance spectrum of each of the green photoresists and D represents a full width at half maximum of a peak of G(λ).

In an embodiment of the present invention, the ratio of M1 to M2 is less than or equal to 0.03.

In an embodiment of the present invention, material of each of the green photoresists includes color index pigment green 36 and color index pigment yellow 150.

In an embodiment of the present invention, material of each of the green photoresists includes color index pigment green 36, color index pigment yellow 150 and color index pigment yellow 139.

In an embodiment of the present invention, the color filter substrate further includes a plurality of blue photoresists and a plurality of red photoresists.

The present invention also provides a liquid crystal display. The liquid crystal display includes a liquid crystal display panel and a backlight module. The liquid crystal display panel has a color filter substrate. The color filter substrate includes a plurality of green photoresists. A ratio of M1 to M2 is less than or equal to 0.04, and D is less than or equal to 90 nm, wherein M1 represents a maximum value of G(λ)×CMF_x(λ) at a wavelength between 450 nm and 510 nm, M2 represents a maximum value of G(λ)×CMF_x(λ) at a wavelength between 550 nm and 590 nm, CMF_x(λ) represents a CIE color matching function, G(λ) represents a transmittance spectrum of each of the green photoresists and D represents a full width at half maximum of a peak of G(λ). The backlight module is disposed adjacent to the liquid crystal display panel for providing a plane light source to the liquid crystal display panel. There is a first relative maximum at a wavelength between 505 nm and 525 nm of a luminous spectrum of the plane light source. There is a second relative maximum at a wavelength between 540 nm and 550 nm of the luminous spectrum of the plane light source.

In an embodiment of the present invention, the ratio of M1 to M2 is less than or equal to 0.03.

In an embodiment of the present invention, material of each of the green photoresists includes color index pigment green 36 and color index pigment yellow 150.

In an embodiment of the present invention, material of each of the green photoresists includes color index pigment green 36, color index pigment yellow 150 and color index pigment yellow 139.

In an embodiment of the present invention, the color filter substrate further includes a plurality of blue photoresists and a plurality of red photoresists.

In an embodiment of the present invention, green exhibited by the liquid crystal display panel corresponding to x and y coordinates of a CIE 1931 chromaticity diagram are respectively Gx and Gy, where Gy≧0.71 and 0.1×Gy+0.15≧Gx≧(−1.13)×Gy+1.

In an embodiment of the present invention, the backlight module includes at least a cold cathode fluorescent lamp.

In the color filter substrate of the present invention, because the full width at half maximum D is less than or equal to 90 nm, and the ratio of M1 to M2 is less than or equal to 0.04, the color saturation of the liquid crystal displays using the color filter substrate of the present invention can be improved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a color space on a CIE 1931 chromaticity diagram of a conventional liquid crystal display employing cold cathode fluorescent lamps and an Adobe RGB color space.

FIG. 2 is a schematic view of a liquid crystal display according to an exemplary embodiment of the present invention.

FIG. 3 is a schematic view of a color filter substrate of the liquid crystal display of FIG. 2.

FIG. 4 shows a color matching function, transmittance spectrums of three green photoresists according to exemplary embodiments of the present invention and transmittance spectrums of two conventional green photoresists.

FIG. 5 shows values of the G(λ)×CMF_x(λ) of the different green photoresists of FIG. 4.

FIG. 6 shows the partial color space on the CIE 1931 chromaticity diagram of the different green photoresists of FIG. 4 and the partial Adobe RGB color space.

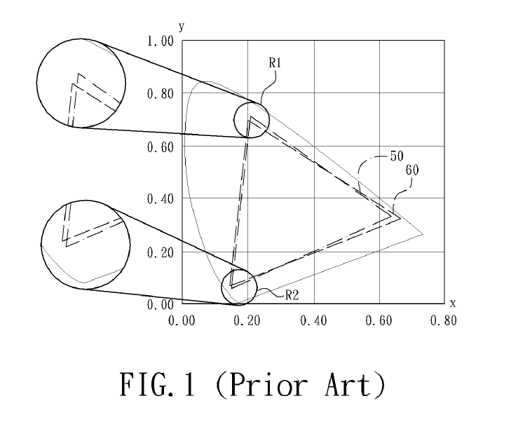

### DETAILED DESCRIPTION

Reference will now be made to the drawings to describe various exemplary embodiments of the present color filter substrate and the liquid crystal display using the color filter substrate in detail.

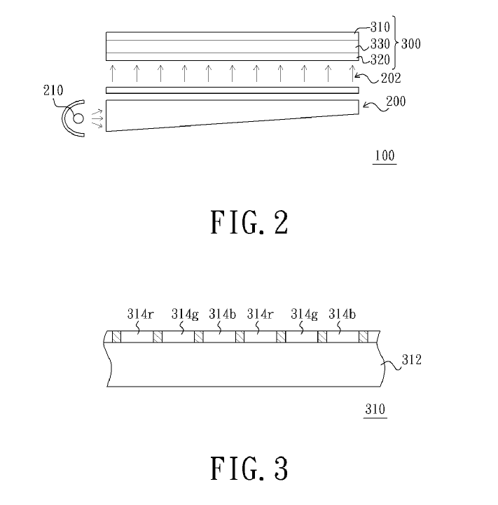

FIG. 2 is a schematic view of a liquid crystal display according to an exemplary embodiment of the present invention. FIG. 3 is a schematic view of a color filter substrate of the liquid crystal display of FIG. 2. Referring to FIGS. 2 and 3, a liquid crystal display 100 includes a backlight module 200 and a liquid crystal display panel 300. The backlight module 200 is disposed adjacent to the liquid crystal display panel 300 for providing a plane light source 202 to the liquid crystal display panel 300. In an illustration embodiment, the backlight module 200 is an edge type backlight module. A light source 210 of the backlight module 200 can be, but not limited to, a cold cathode fluorescent lamp (CCFL). In an alternative embodiment, the backlight module 200 is a direct type backlight module. The liquid crystal display panel 300 may include a color filter substrate 310, an active device array substrate 320 and a liquid crystal layer 330. The active device array substrate 320 can be a thin film transistor array substrate. The liquid crystal layer 330 is located between the color filter substrate 310 and the active device array substrate 320.

The color filter substrate 310 includes a substrate 312 and a plurality of color photoresists. The color photoresists include green photoresists 314g, red photoresists 314r and blue photoresists 314b. In the present embodiment, λ represents a wavelength, G(λ) represents a transmittance spectrum of each of the green photoresists 314g, D represents a full width at half maximum of a peak of G(λ), CMF_x(λ) represents a Commission Internationale de L'Eclairage (CIE) color matching function, M1 represents a maximum value of G(λ)×CMF_x(λ) at a wavelength between 450 nm and 510 nm, and M2 represents a maximum value of G(λ)×CMF_x(λ) at a wavelength between 550 nm and 590 nm. The green photoresists 314g satisfy two conditions. One of the two conditions is that a ratio of M1 to M2 is less than or equal to 0.04, and the other of the two conditions is that D is less than or equal to 90 nm. Preferably, the ratio of M1 to M2 is less than or equal to 0.03.

In the liquid crystal display 100, the color filter substrate 310 can be incorporated in the active device array substrate 320, so as to form a color filter on array substrate (COA Substrate). The backlight module 200 provides the plane light source 202, and there is a first relative maximum at a wavelength between 505 nm and 525 nm of a luminous spectrum of the plane light source 202, and there is a second relative maximum at a wavelength between 540 nm and 550 nm of the luminous spectrum of the plane light source 202.

In the liquid crystal display 100, green exhibited by the liquid crystal display panel 300 corresponding to x and y coordinates of the CIE 1931 chromaticity diagram are respectively Gx and Gy, where Gy≧0.71 and 0.1×Gy+0.15≧Gx≧(−1.13)×Gy+1. In addition, material of each of the green photoresists 314g can include color index pigment green 36 and color index pigment yellow 150. In an alternative embodiment, the material of each of the green photoresists can include color index pigment green 36, color index pigment yellow 150 and color index pigment yellow 139.

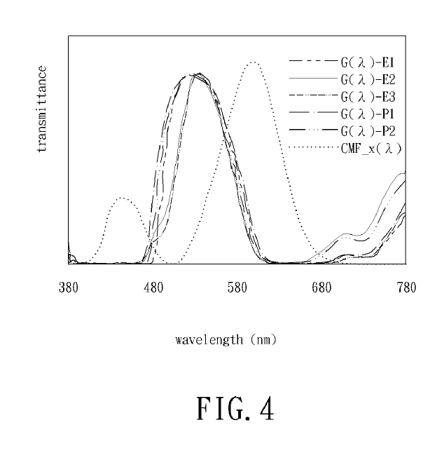

FIG. 4 shows a color matching function, transmittance spectrums of three green photoresists according to exemplary embodiments of the present invention and transmittance spectrums of two conventional green photoresists. As shown in FIG. 4, G(λ)-P1 and G(λ)-P2 represent the transmittance spectrums of two conventional green photoresists. A full width at half maximum of G(λ)-P1 is 98.4 nm, and a full width at half maximum of G(λ)-P2 is 88.7 nm. G(λ)-E1 represents the transmittance spectrum of the green photoresist 314g according to the first exemplary embodiment of the present invention. A full width at half maximum of G(λ)-E1 is 86.3 nm, and the material of the green photoresist 314g includes color index pigment green 36 and color index pigment yellow 150. G(λ)-E2 represents the transmittance spectrum of the green photoresist 314g according to the second exemplary embodiment of the present invention. A full width at half maximum of G(λ)-E2 is 66.7 nm, and the material of the green photoresist 314g includes color index pigment green 36, color index pigment yellow 150 and color index pigment yellow 139. G(λ)-E3 represents the transmittance spectrum of the green photoresist 314g according to the third exemplary embodiment of the present invention. A full width at half maximum of G(λ)-E3 is 64.4 nm, and the material of the green photoresist 314g includes color index pigment green 36, color index pigment yellow 150 and color index pigment yellow 139.

Unlike the conventional technique, the full width at half maximum of the transmittance spectrums of the present invention is relatively small, such as less than 90 nm. Therefore, a color saturation of the liquid crystal display 100 can be improved. In addition, in FIG. 4, the transmittance spectrums of the green photoresists 314g of embodiments of the present invention moves rightwards, so the liquid crystal display 100 can support an Adobe RGB color space.

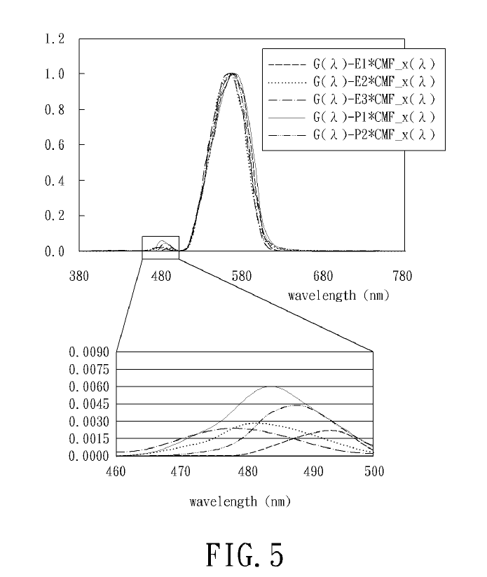

FIG. 5 shows values of the G(λ)×CMF_x(λ) of the different green photoresists of FIG. 4. As shown in FIG. 5, maximum of each of G(λ)-E1×CMF_x(λ), G(λ)-E2×CMF_x(λ), G(λ)-E3×CMF_x(λ), G(λ)-P1×CMF_x(λ) and P2×CMF_x(λ) at the wavelength between 550 nm and 590 nm (M2) is about 1, maximum of each of G(λ)-P1×CMF_x(λ) and P2×CMF_x(λ) at the wavelength between 450 nm and 510 nm (M1) is greater than 0.04, and maximum of each of G(λ)-E1×CMF_x(λ), G(λ)-E2×CMF_x(λ) and G(λ)-E3×CMF_x(λ) at the wavelength between 450 nm and 510 nm (M1) is less than 0.03. Therefore, in the exemplary embodiments of the present invention, the green photoresists 314g can satisfy the following condition: M1/M2≦0.04, thereby transmittance of short wavelength light can be reduced. Consequently, the color saturation of the liquid crystal display 100 can be improved, and the liquid crystal display 100 can support the Adobe RGB color space.

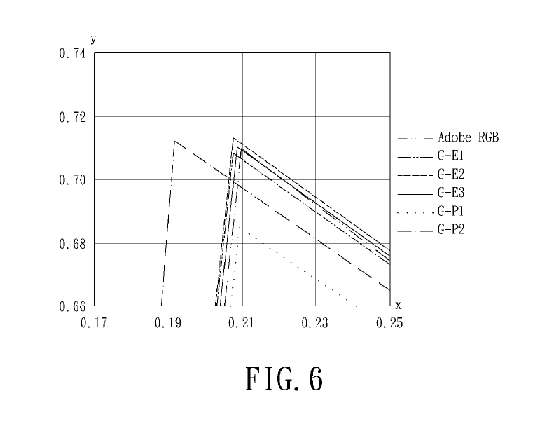

FIG. 6 shows partial color space on the CIE 1931 chromaticity diagram of the different green photoresists of FIG. 4 and the partial Adobe RGB color space. As shown in FIG. 6, G-E1 represents the color space of the liquid crystal display 100 using the green photoresists 314g of the first exemplary embodiment of the present invention, and the green coordinate (Gx, Gy) is (0.208, 0.708). G-E2 represents the color space of the liquid crystal display 100 using the green photoresists 314g of the second exemplary embodiment of the present invention, and the green coordinate (Gx, Gy) is (0.208, 0.713). G-E3 represents the color space of the liquid crystal display 100 using the green photoresists 314g of the third exemplary embodiment of the present invention, and the green coordinate (Gx, Gy) is (0.209, 0.711). G-P1 represents the color space of the liquid crystal display using the conventional green photoresists, and the green coordinate (Gx, Gy) is (0.209, 0.685). G-P2 represents the color space of the liquid crystal display using the other conventional green photoresists, and the green coordinate (Gx, Gy) is (0.192, 0.712). In addition, green coordinate of the Adobe RGB color space is (0.210, 0.710).

As can be seen from FIG. 6, unlike the conventional technique, the color space of the liquid crystal display 100 using the green photoresists 314g of the exemplary embodiments of the present invention may almost cover the Adobe RGB color space. Therefore, the liquid crystal display 100 using the cold cathode fluorescent lamp as the light source can support the Adobe RGB color space.

In the color filter substrates of embodiments of the present invention, because the full width at half maximum D is less than or equal to 90 nm, and the ratio of M1 to M2 is less than or equal to 0.04, the color saturation of the liquid crystal displays using the color filter substrates of embodiments of the present invention can be improved. In addition, even if the liquid crystal displays employ the cold cathode fluorescent lamp as the light source, the liquid crystal displays using the color filter substrates of embodiments of the present invention can support the Adobe RGB color space.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A color filter substrate comprising:
a plurality of green photoresists, a ratio of M1 to M2 being less than or equal to 0.04, and D being less than or equal to 90 nm, wherein M1 represents a maximum value of G(λ)×CMF_x(λ) at a wavelength between 450 nm and 510 nm, M2 represents a maximum value of G(λ)×CMF_x(λ) at a wavelength between 550 nm and 590 nm, CMF_x(λ) represents a Commission Internationale de L'Eclairage (CIE) color matching function, G(λ) represents a transmittance spectrum of each of the green photoresists and D represents a full width at half maximum of a peak of G(λ).

2. The color filter substrate as claimed in claim 1, wherein the ratio of M1 to M2 is less than or equal to 0.03.

3. The color filter substrate as claimed in claim 1, wherein material of each of the green photoresists comprises color index pigment green 36 and color index pigment yellow 150.

4. The color filter substrate as claimed in claim 1, wherein material of each of the green photoresists comprises color index pigment green 36, color index pigment yellow 150 and color index pigment yellow 139.

5. The color filter substrate as claimed in 1, further comprising a plurality of blue photoresists and a plurality of red photoresists.

6. A liquid crystal display comprising:
a liquid crystal display panel having a color filter substrate, the color filter substrate comprising a plurality of green photoresists, a ratio of M1 to M2 being less than or equal to 0.04, and D being less than or equal to 90 nm, wherein M1 represents a maximum value of G(λ)×CMF_x(λ) at a wavelength between 450 nm and 510 nm, M2 represents a maximum value of G(λ)×CMF_x(λ) at a wavelength between 550 nm and 590 nm, CMF_x(λ) represents a Commission Internationale de L'Eclairage (CIE) color matching function, G(λ) represents a transmittance spectrum of each of the green photoresists and D represents a full width at half maximum of a peak of G(λ); and
a backlight module disposed adjacent to the liquid crystal display panel for providing a plane light source to the liquid crystal display panel, there being a first relative maximum at a wavelength between 505 nm and 525 nm of a luminous spectrum of the plane light source, and there being a second relative maximum at a wavelength between 540 nm and 550 nm of the luminous spectrum of the plane light source.

7. The liquid crystal display as claimed in claim 6, wherein the ratio of M1 to M2 is less than or equal to 0.03.

8. The liquid crystal display as claimed in claim 6, wherein material of each of the green photoresists comprises color index pigment green 36 and color index pigment yellow 150.

9. The liquid crystal display as claimed in claim 6, wherein material of each of the green photoresists comprises color index pigment green 36, color index pigment yellow 150 and color index pigment yellow 139.

10. The liquid crystal display as claimed in claim 6, wherein the color filter substrate further comprises a plurality of blue photoresists and a plurality of red photoresists.

11. The liquid crystal display as claimed in claim 6, wherein green exhibited by the liquid crystal display panel corresponding to x and y coordinates of a CIE 1931 chromaticity diagram are respectively Gx and Gy, where Gy≧0.71 and 0.1×Gy+0.15≧Gx≧(−1.13)×Gy+1.

12. The liquid crystal display as claimed in claim 6, wherein the backlight module comprises at least a cold cathode fluorescent lamp.
